(19) United States
(12) Patent Application Publication
(10) Pub. No.: US 2020/0373549 A1
(43) Pub. Date: Nov. 26, 2020

(54) POUCH TYPE LITHIUM SECONDARY BATTERY PREVENTING INTERNAL SHORT CIRCUIT

(71) Applicants: HYUNDAI MOTOR COMPANY, Seoul (KR); KIA MOTORS CORPORATION, Seoul (KR)

(72) Inventors: Jong Chan Song, Suwon-si (KR); Gwang Seok Oh, Seoul (KR); Eun Ji Kwon, Hwaseong-si (KR)

(73) Assignees: HYUNDAI MOTOR COMPANY, Seoul (KR); KIA MOTORS CORPORATION, Seoul (KR)

(21) Appl. No.: 16/695,423

(22) Filed: Nov. 26, 2019

(30) Foreign Application Priority Data
May 20, 2019 (KR) 10-2019-0058649

(51) Int. Cl. H01M 2/34; H01M 10/0525; H01M 2/02

(52) U.S. Cl. CPC H01M 2/34; H01M 2/0275; H01M 10/0525

(57) ABSTRACT

A pouch type lithium secondary battery includes: a lead tab-protecting member to suppress occurrence of an electrical short circuit with a lead tab due to a dendrite formed in a positive electrode during charge and discharge of the pouch type lithium secondary battery.

### CROSS REFERENCE TO RELATED APPLICATION

The present application claims priority to and the benefit of Korean Patent Application No. 10-2019-0058649, filed on May 20, 2019, the entire contents of which are incorporated herein by reference.

### FIELD

The present disclosure relates to a pouch type lithium secondary battery.

### BACKGROUND

The statements in this section merely provide background information related to the present disclosure and may not constitute prior art.

In the case of a lithium ion battery which is currently used as a power source for a portable electronic device and an electric vehicle, a pouch type secondary battery, which is easy to deform in shape, low in manufacturing cost, and light in weight as compared with a cylindrical or square type, is widely used. For the same reason, other than the lithium ion battery, next-generation batteries after lithium-ion batteries, such as lithium air secondary batteries, lithium sulfur secondary batteries, and lithium metal secondary batteries, are also being developed mainly in the form of pouches.

Most of the pouch type secondary batteries have a lead tab drawn from an electrode group, and the lead tab and an external material (pouch) are sealed by a sealing film. The sealing film is localized to a thermally bonded portion between the pouch and the lead tab.

Meanwhile, the lithium metal secondary battery is a battery that uses a lithium metal or lithium alloy as a positive electrode, and has a theoretically very high energy capacity. However, in the lithium metal secondary battery, lithium is deposited only in a specific region to form a lithium dendrite, which is a dendritic precipitate, and the dendrite may pass through a separator and reach an negative electrode, which may cause a short circuit of the battery or explosion of the battery. Thus, stabilizing an interface between the lithium metal and an electrolyte is a major issue.

Conventionally, there is known a technique of coating a lithium protective film or a separator with ceramic particles to prevent a short circuit, but the technique fails to properly block the dendrite grown on the electrode side portion.

FIG. 1 briefly illustrates a problem of a short circuit occurring in the conventional pouch type lithium metal battery. In the process of charge and discharge of the pouch type lithium metal battery, lithium is precipitated on the surface of a positive electrode material layer 220′ to grow a dendrite 2. Here, the dendrite 2 grows through a space between a separator 300′ and a pouch (not shown), and is brought into contact with a lead tab 130′ connected to an negative electrode material layer 120′ or an negative electrode current collector 110′, whereby a short circuit occurs.

The foregoing is intended merely to aid in the understanding of the background of the present disclosure, and is not intended to mean that the present disclosure falls within the purview of the related art that is already known to those skilled in the art.

### SUMMARY

The present disclosure proposes a pouch type lithium secondary battery, which is capable of effectively blocking contact between the lead tab and the dendrite that is formed at the positive electrode and grows along the side of the electrode assembly due to charge and discharge.

The above and other related objects and features of the present disclosure will be apparent from a reading of the following description of the disclosure found in the accompanying drawings and the novelty thereof pointed out in the appended claims.

In order to achieve the above object, according to one aspect of the present disclosure, a pouch type lithium secondary battery may include: an electrode assembly; a lead tab connected to the electrode assembly and exposed toward a side of the electrode assembly; a lead tab-protecting member surrounding the lead tab to insulate the lead tab; and a pouch configured to receive and seal the electrode assembly while a part of the lead tab is exposed to an outside of the pouch.

The electrode assembly may include: an negative electrode including an negative electrode material layer, and an negative electrode current collector; a positive electrode; and a separator interposed between the negative electrode and the positive electrode, and the lead tab may be connected to the negative electrode current collector and the positive electrode, respectively.

The separator may be equal to or larger than areas of the negative electrode and the positive electrode.

The lead tab may include: an negative electrode lead tab connected to the negative electrode current collector; and a positive electrode lead tab connected to the positive electrode.

The positive electrode may include a lithium metal.

The lead tab may include at least one of copper (Cu), nickel coated Cu, aluminum (Al), nickel (Ni), carbon coated Al, or stainless steel (SUS).

The lead tab may include a first area (a) being in contact with the pouch, a second area (b) positioned inside the pouch, and a third area (c) being exposed outside the pouch, and the lead tab-protecting member may be positioned in the second area (b) of the lead tab.

The secondary battery may further include a sealing film interposed between the pouch and the lead tab to fill a space between the pouch and the lead tab, thereby sealing an inside of the pouch from the outside.

The sealing film may include an insulating material selected from a group consisting of ethylene vinyl acetate, polystyrene, polypropylene, polyethylene terephthalate, polyethylene naphthalate, polybutylene terephthalate, polybutylene naphthalate, polyimide, and a combination thereof.

The lead tab-protecting member may be in contact with the sealing film.

The lead tab-protecting member may be in a form of at least one of a coating layer and a film.

The lead tab-protecting member may include an insulating material selected from a group consisting of polyethylene, polyvinyl chloride, natural rubber, polyester, epoxy, phenol, polyurethane, polyethylene terephthalate, polyamide, polyimide, polypropylene, Teflon, aluminum oxide (Al2O3), silicon dioxide (SiO2), titanium dioxide (TiO2), and a combination thereof.

The lead tab-protecting member may have a thickness of from 1 μm to 50 μm.

The pouch may include bonding edges formed by thermally bonding edges of inner surfaces of the pouch in which the electrode assembly is accommodated.

The bonding edges of the pouch may be applied with an adhesive.

The pouch may be sealed by thermally bonding the bonding edges together and by thermally bonding the bonding edges of the pouch and the lead tab together.

According to the present disclosure, it is possible to effectively block contact between the lead tab and the dendrite that is formed at the positive electrode and grows along the side of the electrode assembly due to charge and discharge.

The effect of the present disclosure is not limited to the effects mentioned above. The effect of the present disclosure should be understood to include all inferable effects in the following description.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 schematically shows a conventional lithium metal battery and a short circuit occurrence process,

FIG. 2 shows a side view of an electrode assembly with a lead tab connected thereto;

FIG. 3 shows a plan view of a pouch type lithium secondary battery;

FIG. 4 shows that short circuit phenomenon is prevented by a lead tab-protecting member;

FIG. 5 is a photograph of occurrence of an electrode short circuit after an experiment of comparative example 1;

FIG. 6 shows a charge and discharge curve of the comparative example 1;

FIG. 7 shows a change in capacity according to a charge and discharge cycle of the comparative example 1;

FIG. 8 shows changes in current and voltage according to charge and discharge in the comparative example 1;

FIG. 9 is a photograph of the lead tab and the electrode assembly to which the lead tab-protecting member is applied before an experiment of a form 1;

FIG. 10 shows a charge and discharge curve of the form 1; and

FIG. 11 shows a change in capacity according to a charge and discharge cycle of the form 1.

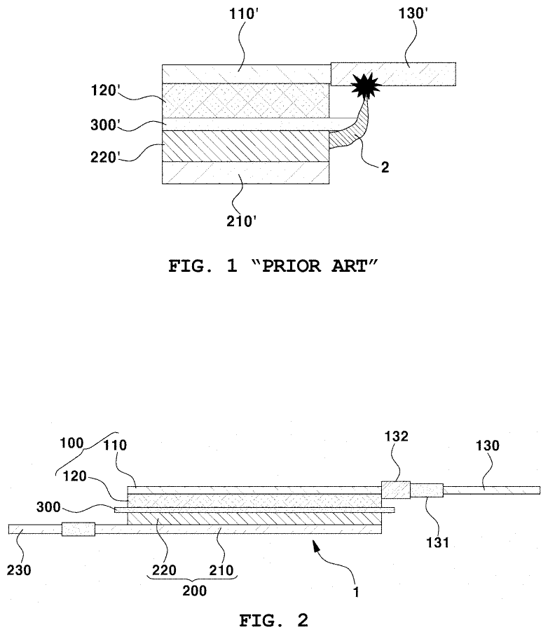

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The above and other objects, advantages and features of the present disclosure will become apparent with reference to the forms described in detail below with reference to the accompanying drawings. However, it should be understood that the form of the present disclosure may be changed to a variety of forms and the scope and spirit of the present disclosure are not limited to the form described hereinbelow. The form of the present disclosure described hereinbelow is provided for allowing those skilled in the art to more clearly comprehend the present disclosure.

It should be understood that the shape and size of the elements shown in the drawings may be exaggeratedly drawn to provide an easily understood description of the structure of the present disclosure. It should be understood that, although the terms first, second, etc. may be used herein to describe various elements, these elements should not be limited by these terms. These terms are only used to distinguish one element, from another element. For instance, a first element discussed below could be tamed a second element without departing from the teachings of the present disclosure. Similarly, the second element could also be termed the first element. As used herein, the singular forms are intended to include the plural forms as well, unless the context clearly indicates otherwise.

It should be further understood that the terms “comprises”, “comprising”, “includes”, and/or “including” when used in this specification, specify the presence of stated features, regions, integers, steps, operations, elements and/or components, but do not preclude the presence or addition of one or more other features, regions, integers, steps, operations, elements, components and/or groups thereof. Further, if it is described that a part such as a layer, film, region, plate, and the like is referred to as being “on” another part, it may be provided “directly on” another portion, or a further part may be interposed between parts. In contrast, if it is described that a part such as a layer, film, region, plate, and the like is referred to as being “below” another part, it may be provided “directly beneath” another portion, or a further part may be interposed between parts. In contrast, it should be understood that when an element is referred to as being “directly coupled” or “directly connected” to another element, there are no intervening elements present. Further, the terms used herein to describe a relationship between elements, for example, “between”, “directly between”, “adjacent”, or “directly adjacent” should be interpreted in the same manner as those described above

The present disclosure relates to a pouch type lithium secondary battery, in which a lead tab protecting member is employed to suppress occurrence of an electrical short circuit with a lead tab due to a dendrite formed in a positive electrode during charge and discharge of the pouch type lithium secondary battery.

To be specific, the pouch type lithium secondary battery of the present disclosure includes: an electrode assembly; a lead tab being connected to the electrode assembly and protruding toward a side of the electrode assembly; a lead tab-protecting member surrounding the lead tab to insulate the lead tab; and a pouch receiving and sealing the electrode assembly while a part of the lead tab is exposed to an outside.

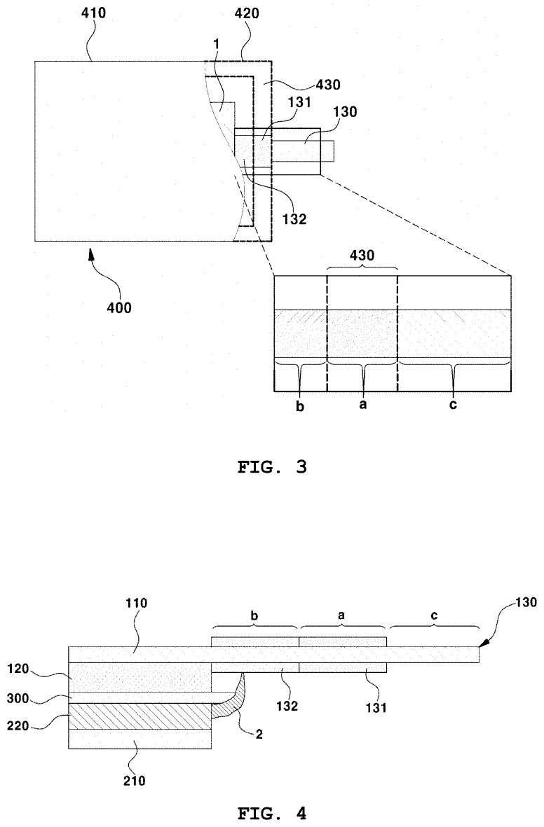

FIGS. 2 and 3 show a structure of the pouch type lithium secondary battery in one form of the present disclosure. With reference to these, each configuration will be described in detail. However, in the present disclosure, it is shown that one electrode assembly is accommodated in the pouch for the convenience of explanation, and a structure in which a plurality of electrode assemblies are stacked may be accommodated in the pouch.

With reference to FIG. 2 that shows a side view of the electrode assembly, and the lead tab connected to the electrode assembly, the electrode assembly may include: an negative electrode 100 including an negative electrode material layer 120, and an negative electrode current collector 110; a positive electrode 200; and a separator 300 interposed between the negative electrode 100 and the positive electrode 200. The positive electrode 200 may include a positive electrode material layer 220, and a positive electrode current collector 210.

The negative electrode material layer 120 may include an active material that can be used in a conventional lithium secondary battery, and in one form, a lithium metal may be used for the positive electrode material layer 220.

The separator 300 may be equal to or larger than areas of the negative electrode 100 and the positive electrode 200, but may be larger than areas of the negative electrode 100 and the positive electrode 200 in order to prevent short circuit due to the initial growth of dendrite formed in the positive electrode 200. Here, the kind of the separator 300 of the present disclosure is not particularly limited, and a separator 300 commonly used in the lithium ion battery technology is sufficient.

The lead tab may be a shape connected to the negative electrode 100 and the positive electrode 200, respectively, wherein when the negative electrode 100 and the positive electrode 200 include the negative electrode current collector 110 and the positive electrode current collector 210, the lead tab is connected to the negative electrode current collector 110 and the positive electrode current collector 210, respectively.

When the negative electrode 100 and the positive electrode 200 do not include collectors, the lead tab may be connected to the negative electrode material layer 120 or the positive electrode material layer 220. Herein, the term connection or connect means that the connection is provided so as to provide a passage through which current flows without being electrically resisted, and a connection method is not particularly limited.

The lead tab includes an negative electrode lead tab 130 connected to the negative electrode 100, and a positive electrode lead tab 230 connected to the positive electrode 200.

The lead tab may be one connected in series such that the electrode assembly is connected to an outer lead of the pouch, but may be connected to the outer lead of the pouch by connecting be a plurality of lead tabs to one lead tab as needed. In other words, for example, when there is a plurality of electrode assemblies accommodated in the pouch, there may be a plurality of negative electrode lead tabs 130 connected to the negative electrode 100. Here, the plurality of negative electrode lead tabs 130 may be connected to one lead tab and exposed to the outside of the pouch.

The lead tab includes a conductive material, wherein the lead tab generally includes at least one of copper (Cu), nickel coated Cu, aluminum (Al), nickel (Ni), carbon coated Al, and stainless steel (SUS).

The pouch type lithium secondary battery may further include a sealing film 131 interposed between the pouch and the lead tab to fill a space between the pouch and the lead tab, thereby sealing an inside of the pouch from the outside. The sealing film 131 may also serve to fix the lead tab to the pouch.

With reference to FIG. 3, the pouch 400 is constituted by an upper sheet 410 and a lower sheet 420. The edges of the upper sheet 410 and the lower sheet 420 of the pouch 400 may be thermally bonded together to form a seal. A portion thermally bonded along the edge of the pouch 400 is referred to as a bonding edge 430. The pouch 400 may be configured such that the bonding edges 430 are thermally bonded together, or the bonding edges 430 of the pouch 400 and the lead tab are thermally bonded together to form a seal.

The bonding edges 430 may be additionally applied with an adhesive, and as the adhesive, an adhesive commonly used when thermally bonding the pouch 400 in the field of dealing with pouch type lithium secondary batteries is sufficient.

The upper sheet 410 and the lower sheet 420 of the pouch 400 are thermally bonded with the sealing film 131 attached on the lead tab. Here, the sealing film 131 may be positioned at the bonding edges 430 of the pouch 400 to be partially or completely melted. Further, the sealing film 131 may serve as a sealant for sealing the inside and the outside of the pouch 400.

The sealing film 131 includes a material selected from a group consisting of ethylene vinyl acetate, polystyrene, polypropylene, polyethylene terephthalate, polyethylene naphthalate, polybutylene terephthalate, polybutylene naphthalate, polyimide, and a combination thereof. However, the material is not limited thereto, and it may be a material which is appropriately melted by heat to perform the adhesive and the sealing function.

With reference to FIG. 3, the lead tab may be divided into several areas. To be specific, the lead tab includes: a first area a being in contact with the bonding edges 430 of the pouch 400 while being pressed against the same; a second area b positioned inside the pouch 400 based on the bonding edges 430 of the pouch 400; and a third area c being exposed outside the pouch 400.

Although in FIG. 3, the first area a, the second area b, and the third area c are divided based on the negative electrode lead tab 130, this is also applicable to the positive electrode lead tab 230.

Here, the first area a where the pouch 400 and the lead tab is in contact with each other corresponds to the bonding edges 430 of the pouch 400.

The third area c is for connecting the electrode assembly 1 accommodated in the pouch 400 to the outer lead together.

The second area b is positioned in the same space as the electrode assembly 1 inside the pouch 400. Therefore, the second area b is an area that is highly likely to be brought into contact with the dendrite grown on the side of the positive electrode 200.

To inhibit or prevent a short circuit between the lithium dendrite grown from the electrode and the lead tab in the second area b of the lead tab, the second area b of the lead tab is surrounded and insulated by the lead tab-protecting member 132.

With reference to FIG. 4, the sealing film 131 is attached to the first area a of the lead tab 130. Also, the second area b of the lead tab 130 is surrounded by the lead tab-protecting member 132.

The lead tab-protecting member 132 is positioned in the second area b of the lead tab 130, and here, the lead tab-protecting member 132 is brought in contact with the sealing film 131 positioned in the first area a. In one form, there is no gap between the lead tab-protecting member 132 and the sealing film 131, and the lead tab 130 is not exposed to the outside at any portion.

The sealing film 131 is positioned in the bonding edges of the pouch, and the lead tab-protecting member 132 is positioned inside the bonding edges, that is, inside the pouch. More precisely, the lead tab-protecting member 132 surrounds the entire surface of the lead tab 130 exposed from the electrode assembly to the sealing film 131.

The lead tab-protecting member 132 may be in the form of at least one of a coating layer and a film.

The lead tab-protecting member 132 includes an insulating material selected from a group consisting of polyethylene, polyvinyl chloride, natural rubber, polyester, epoxy, phenol, polyurethane, polyethylene terephthalate, polyamide, polyimide, polypropylene, Teflon, aluminum oxide (Al2O3), silicon dioxide (SiO2), titanium dioxide (TiO2), and a combination thereof.

The coating layer may be formed by applying or depositing a resin including an insulating material. Here, the lead tab-protecting member 132 has a thickness of from 1 μm to 50 μm.

The film may be wrapped around the lead tab 130 using an adhesive or the like. Here, the film formed on the lead tab 130 has a thickness of from 1 μm to 50 μm.

Hereinafter, the present disclosure will be described in more detail through specific forms. However, the forms of the present disclosure are disclosed only for illustrative purposes and should not be construed as limiting the present disclosure.

Form 1

An negative electrode slurry was prepared by mixing nickel-magnesium-cobalt (NMC811), polyvinylidene fluoride (PVdF) and N-methylpyrrolidone, and the negative electrode slurry was coated on an aluminum foil as a current collector and sufficiently dried to prepare an negative electrode material layer. A positive electrode material layer was prepared from a lithium metal thin film having a thickness of about 45 μm. An electrode assembly was fabricated by interposing a polyethylene separator between the negative electrode material layer and the positive electrode material layer. An aluminum lead tab was connected to the negative electrode material layer and the positive electrode material layer of the electrode assembly. A polyethylene terephthalate sealing film was attached to the portion of the lead tab brought in contact with the pouch. A polyimide film as a lead tab-protecting member was wrapped several times to have a thickness of 7 μm and attached between the sealing film and the electrode assembly.

The lead tab with the sealing film attached thereto, and the electrode assembly connected to the lead tab were seated on the lower surface of the pouch. A pouch type lithium secondary battery was manufactured by thermally bonding the upper surface of the pouch to the lower surface of the pouch. Here, a liquid electrolyte was added between the negative electrode and the positive electrode.

### Comparative Example 1

A pouch-type lithium secondary battery was manufactured in the same manner as in the form 1 except that the lead tab-protecting member was not attached thereto.

### Experimental Example

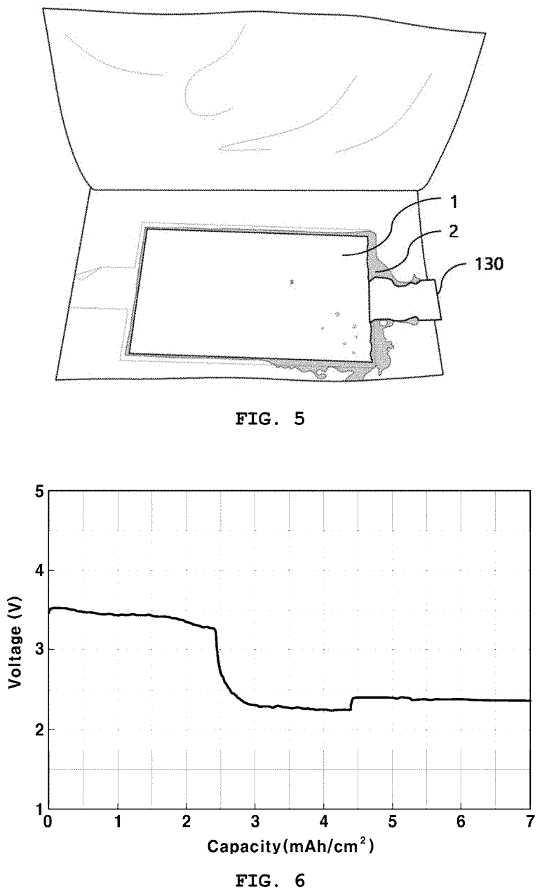

An experiment, in which the pouch type lithium secondary battery manufactured in the comparative example 1 and form 1 is charged and discharged, was conducted. The results are shown in FIGS. 5 to 11.

FIG. 5 is a photograph of a dendrite formed while charging the pouch type lithium secondary battery manufactured in the comparative example 1 and a contact short circuit phenomenon caused by the dendrite. It can be seen that the dendrite formed at the positive electrode toward the side of the electrode assembly penetrated to the negative electrode lead tab through the separator.

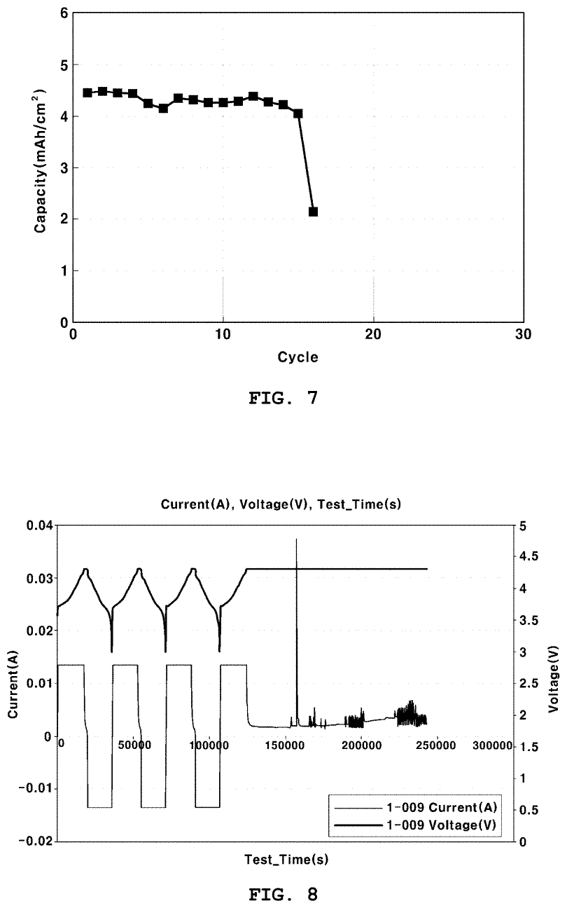

FIG. 6 shows a charge curve of the comparative example 1, wherein it can be confirmed that a normal voltage rise fails during charge due to a short circuit in the negative electrode lead tab part, and an overcharge phenomenon appears due to potential degradation and potential plateau. With reference to FIG. 7, it can be confirmed that in the event of overcharge due to a short circuit, it is not possible to terminate a cycle due to the arrival of the end potential of the charge, so that a normal charge and discharge cycle cannot be driven.

With reference to FIG. 8, it can be confirmed that the current value generated in the constant voltage charging mode does not continuously decrease, and the overcurrent occurs due to the current leakage due to the short circuit.

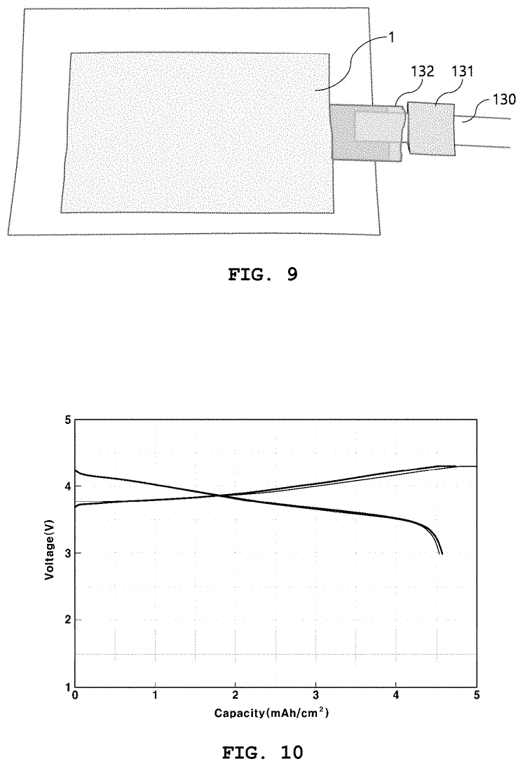

FIG. 9 is a photograph of a pouch type lithium secondary battery to which the lead tab-protecting member manufactured in the form 1 is applied. Referring to this, it can be seen that the lead tab is surrounded by the lead tab-protecting member between the sealing film and the electrode assembly.

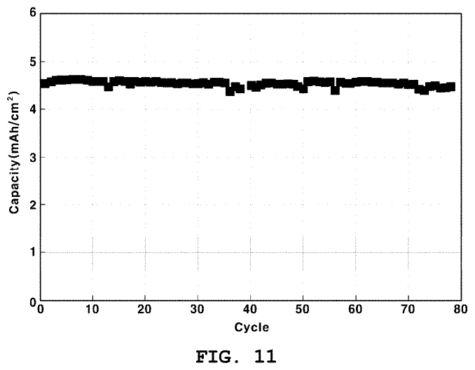

FIG. 10 shows a charge and discharge curve of the pouch type lithium secondary battery of the form 1. Referring to this, it can be confirmed that the lithium secondary battery has achieved a normal full charge condition without overcharge phenomenon, so that the charge and discharge cycle is smoothly progressing. It can be seen from FIG. 11 that the charge and discharge is stably performed until the charge and discharge cycle reaches 80 times.

Comparing the results of the form 1 and the comparative example 1, it can be confirmed that a problem of an indirect short circuit with the lead tab due to the dendrite formed in the internal space of the pouch was solved by application of the lead tab-protecting member.

What is claimed is:

1. A pouch type lithium secondary battery, comprising:
an electrode assembly;
a lead tab connected to the electrode assembly and exposed toward a side of the electrode assembly;
a lead tab-protecting member surrounding the lead tab and configured to insulate the lead tab; and
a pouch configured to receive and seal the electrode assembly while a part of the lead tab is exposed to an outside of the pouch.

2. The pouch type lithium secondary battery of claim 1, wherein the electrode assembly includes:
a negative electrode including a negative electrode material layer, and a negative electrode current collector;
a positive electrode; and
a separator interposed between the negative electrode and the positive electrode, and
wherein the lead tab is connected to the negative electrode current collector and the positive electrode, respectively.

3. The pouch type lithium secondary battery of claim 2, wherein the separator is equal to or larger than areas of the negative electrode and the positive electrode.

4. The pouch type lithium secondary battery of claim 3, wherein the positive electrode includes a lithium metal.

5. The pouch type lithium secondary battery of claim 2, wherein the lead tab includes:
a negative electrode lead tab connected to the negative electrode current collector; and
a positive electrode lead tab connected to the positive electrode.

6. The pouch type lithium secondary battery of claim 1, wherein the lead tab includes at least one of copper (Cu), nickel coated Cu, aluminum (Al), nickel (Ni), carbon coated Al, or stainless steel (SUS).

7. The pouch type lithium secondary battery of claim 1, wherein the lead tab includes: a first area in contact with the pouch, a second area positioned inside the pouch, and a third area exposed outside the pouch, and
wherein the lead tab-protecting member is positioned in the second area of the lead tab.

8. The pouch type lithium secondary battery of claim 1, further comprising:
a sealing film interposed between the pouch and the lead tab and configured to fill a space between the pouch and the lead tab, thereby sealing an inside of the pouch from the outside.

9. The pouch type lithium secondary battery of claim 8, wherein the sealing film includes: an insulating material selected from a group consisting of ethylene vinyl acetate, polystyrene, polypropylene, polyethylene terephthalate, polyethylene naphthalate, polybutylene terephthalate, polybutylene naphthalate, polyimide, and a combination thereof.

10. The pouch type lithium secondary battery of claim 8, wherein the lead tab-protecting member is in contact with the sealing film.

11. The pouch type lithium secondary battery of claim 1, wherein the lead tab-protecting member is in a form of at least one of a coating layer or a film.

12. The pouch type lithium secondary battery of claim 11, wherein the lead tab-protecting member includes an insulating material selected from a group consisting of polyethylene, polyvinyl chloride, natural rubber, polyester, epoxy, phenol, polyurethane, polyethylene terephthalate, polyamide, polyimide, polypropylene, Teflon, aluminum oxide (Al2O3), silicon dioxide (SiO2), titanium dioxide (TiO2), and a combination thereof.

13. The pouch type lithium secondary battery of claim 1, wherein the lead tab-protecting member has a thickness of from 1 μm to 50 μm.

14. The pouch type lithium secondary battery of claim 1, wherein the pouch includes bonding edges formed by thermally bonding edges of inner surfaces of the pouch in which the electrode assembly is accommodated.

15. The pouch type lithium secondary battery of claim 14, wherein the bonding edges of the pouch are applied with an adhesive.

16. The pouch type lithium secondary battery of claim 14, wherein the pouch is sealed by thermally bonding the bonding edges together and by thermally bonding the bonding edges of the pouch and the lead tab together.
